(19) United States
(12) Patent Application Publication
(10) Pub. No.: US 2009/0179122 A1
(43) Pub. Date: Jul. 16, 2009

(54) Modular boat support

(76) Inventor: James Inzero, Point Pleasant Beach, NJ (US)

Correspondence Address: GEARHART LAW, LLC, 4 FERNDALE ROAD, CHATHAM, NJ, 07928, US

(21) Appl. No.: 12/315,006

(22) Filed: Nov. 26, 2008

Related U.S. Application Data
(60) Provisional application No. 61/005,035, filed on Nov. 30, 2007.

(51) Int. Cl. F16M 11/00

(52) U.S. Cl. 248/157; 248/127

(57) ABSTRACT

The invention provides a unique modular boat support that supports boats on dry land. The modular boat supports are stackable to achieve any desired height, and are made from a strong yet relatively light material. The modular body contains a reinforcement structure and an interconnect assembly that stabilize the structure when units are stacked together. The preferred shape is conical, but any shape may be used.

### CLAIM OF PRIORITY

This application claims the priority of U.S. Ser. No. 61/005,035 filed on Nov. 30, 2007, which is incorporated herein by reference.

### FIELD OF THE INVENTION

The present invention relates generally to shoring type devices for supporting boats on dry land for maintenance and storage, and particularly to a boat support that is lightweight but strong, easy to transport and store, and is stackable to provide adjustable height which enables it to be used with a wide variety of boat types. Although designed primarily for use with boats, the present invention is not limited in use to boats; it can be used with any structure that requires support.

### BACKGROUND OF THE INVENTION

The present invention relates to devices employed for supporting boats on dry land. Various types of shoring structures and devices have been used for supporting boats for dry dock storage and maintenance. Because of the wide variety of hull shapes, keels and boat sizes, these supports have generally been custom constructed at the maintenance or storage site for particular boats using wood blocks, cinder blocks, tie rods, and jack stands. As an alternative, boat stand assemblies have been devised for supporting boats in dry dock. However, if one visits a temporary storage or maintenance site, a common sight is to see boats resting on stacked cinder blocks, which support the boats on the sides while the hull is blocked with wood or cinderblocks on the ground. Cinder blocks are used because they are easily stackable and therefore are easily customized to the boat at hand, but they have disadvantages. These include a lack of stability in a stack, the difficulty of storing and moving the blocks, which may require a forklift, and the occurrence of abrasion on the boat hull from contact with the uneven surface of the hard cinderblock. In addition, many people find the cinderblocks unsightly. Alternative devices have been employed to stabilize boats in dry dock; those relevant to the present invention, as well as other types of stabilizing devices for use in other areas, are described below.

U.S. Pat. No. 5,290,124 teaches boat stand assemblies for dry dock maintenance or storage of boats with and without keels including two or more rigid frames of adjustable width, each including a pair of struts of adjustable height, the frames being connectable by cross braces to provide a complete stand and further including a keel stand assembly similarly constructed of height and spacing adjustable struts.

U.S. Pat. No. RE 33,930 teaches systems provided to support marine craft comprising a plurality of support apparatus. Each support apparatus is comprised of a surface for contact with the marine craft, an extension member which is fastened at one end to a base and connected pivotably at its other end to the surface, and the base. The base provides means for fixedly engaging and retaining the extension member at a given orientation. The base is attached to the extension member at its end remote from the end which is connected to the surface. In addition, the base provides means for adjustably connecting the base to adjacent bases, which in turn engage adjacent extension members. The plurality of support apparatus are arranged such that a marine craft which contacts the surfaces of the support device is supported in a stationary position.

U.S. Pat. No. 4,756,642 teaches a system for storage and shipping of boats availing of a series of adjustable support units which are connected by flexible elements to each other to prevent lateral and longitudinal movement of the boat with respect to its supported location, the support units likewise providing for fastening of a boat to the units by other flexible elements.

U.S. Pat. No. 4,468,150 teaches an adjustable boat cradle for supporting a boat. There is disclosed a rectangular base frame structure with a plurality of adjustable vertical support assemblies strategically located and connected to the base frame structure. Typically said vertical support assemblies extend generally upwardly from at least the corner areas of the base frame structure and includes an upper cradle pad that actually engages a side portion of the boat's hull while the keel of the boat is directly supported by an underlying support. To accommodate hulls of various sizes and shapes, the effective length and angle of orientation of the vertical support assemblies can be conveniently adjusted. In addition, the cradle pads are universally mounted about the vertical support assemblies such that they will rest adjacent the hull irrespective of the orientation of the support structure comprising the respective vertical support assemblies.

U.S. Pat. No. 6,253,699 teaches a watercraft beaching device that includes one or more collapsible upright supports which hold a pair cushioned hull engagement surfaces in spaced apart relationship. Advantageously, hull engagement surfaces are elongated to engage more than a single point or area along on side of the hull of watercraft to prevent watercraft from pivoting about the mooring point on the shoreline. Additionally, supports are configured to hold hull engagement surfaces a sufficient distance above the shoreline to insure that the hull does not come into contact with the aforementioned abrasive agents or shoreline.

U.S. Pat. No. 6,439,543 teaches a leveling device for a recreational vehicle, including a plurality of supports each having a bottom wall, a top wall and a peripheral wall that extends between the top and bottom walls. Each of the bottom walls has a generally rectangular shape. Each of the front walls is angled outward and downward from the top walls to the bottom walls. The supports is stacked on each other with the back walls generally aligned and the bottom walls abutting the top walls such that an upper most support and a lower most support is defined. Each of the bottom walls has a size and shape generally equal to an abutting top wall such that the front walls define a ramp. A selected number of the supports are stacked such that a desired height is achieved. The tire is positioned on the supports such that the recreational vehicle is vertically supported.

U.S. Pat. No. 7,198,000 teaches a hydrofoil craft that includes a hull having a longitudinal axis, a pylori secured to and extending beneath the hull and a lifting foil secured to the pylori. The lifting foil has an upper surface and a lower surface. The upper surface of the lifting foil is substantially planar and the lower surface of the lifting foil is not coplanar with the upper lifting surface. The lifting foil has a fore portion and an aft portion that are traversed by a longitudinal axis and wherein the longitudinal axis is substantially parallel to the longitudinal axis of the hull and the thickness of the foil is greater at the aft portion than at the fore portion.

U.S. Pat. No. 6,334,598 teaches an apparatus for supporting low-ground-clearance vehicles, such as fork lift trucks or airport maintenance vehicles during servicing. End and side panels, welded together to form a frusto-pyramid, are surmounted by a dished wheel-receiving platform, for supporting a truck etc wheel. The units are wide open underneath, for stacking. Hand holes in the end panels allow the units to be manhandled and stacked. A cross-brace under the platform strengthens the structure, and holds the stacked units apart.

US Publication No. 2005/0211868 teaches a modular support system for supporting structures and other loads in buildings, including, three or more support members, three or more load transferring elements configured to couple to one end of the three or more support members to form a support surface, and three or more coupling structures configured to couple to the opposite end of the three or more support members, wherein the system is configured to distribute a supported load about the three or more support members and three or more coupling structures.

International Publication No. WO/2000/047829 teaches an interlocking segmental retaining wall for landscaping and construction use. The wall includes a plurality of blocks stacked upon each other. Each block includes a void filled with aggregate. In addition, each block includes an extension and slot for interlocking the blocks together to form the retaining wall. Each block also includes a plurality of lugs and an indentation for aligning and stacking the blocks on each other. The blocks may also be stacked to form a curved retaining wall. In an alternate embodiment, the blocks may have tabs located on an upper portion of each block. Each block is laterally positioned by centering the block upon the top of two lower blocks.

International Publication No. WO/2000/070154 teaches a meshing type stack block that can be used to construct retaining walls and other structures and laid structures, and a device for producing the same. A meshing type stack block and a device for producing gradient-compatible meshing type stack blocks, wherein a retaining wall can be constructed, even if the operator is not skilled, in a short time simply by a stacking operation once a foundation base for the retaining wall has been constructed, and there is no need for in-site work, including the placing of mixer concrete for wedge blocks, the placing of concrete at corners of a retaining wall, and the filling of joints, nor is the need for a professional worker, and wherein when a structure, such as a retaining wall, or a laid structure becomes unnecessary, it can be reused by disassembling the blocks.

U.S. Pat. No. 6,546,686 teaches a stabilization system that includes a foundation platform that supports a pier, with the pier in turn supporting the joists of a premanufactured building structure. Cleat walls at the edges of the central body portion of the foundation platform extend into the ground. Struts are sloped upwardly from the foundation platform for connection to an adjacent joist. The weight of the building structure and the cleat walls prevent the foundation platform from horizontal movement. Thus, horizontal movement of the building structure is resisted without the application of horizontal forces to the pier.

U.S. Pat. Nos. 5,290,124, RE33,930, 4,756,642, and 4,468,150 present cradles for boat storage; U.S. Pat. No. 6,253,699 presents a beaching device, U.S. Pat. No. 7,198,000 relates to hydrofoils, and the other patents cited above are stabilizing devices for vehicles or construction.

None of the aforementioned prior art references teach the features of the present invention. The present invention is lightweight, stackable, and provides an optional contact extension that is made from a non-abrasive material and is deformable, thereby protecting the boat hull from scratches. The stackable aspect makes height adjustment quick and easy, as does the availability of different sizes of the device. Different sizes of the device make it suitable for different hull shapes, or even for different spots on the hull.

Another advantage of the present invention is that, unlike a cradle, each support operates independently, making them much easier to use and adjust when settling a boat onto them, or when placing them on the sides of the hull. The operator is not limited to the number of support points dictated by the cradle, and one can also easily add support without having to adjust a frame. Thus, one can customize the support of one's boat in the yard quickly, easily, and efficiently. In addition, the modular boat support of the present invention takes up less space in the boatyard than many available cradles, either when in use or when in storage. It is also easily adaptable to any size boat or hull shape.

The present invention is more aesthetically pleasing than cinder blocks or other supports, and the appearance can be customized to the owner's taste. For instance, a boat owner may paint the modular boat support to match his boat, may custom order a color or design for the boat support body, or even have his name or the boat's name painted or printed on the support, thus making it easy to identify his supports in a warehouse or yard full of the same. It is also more readily disposable than other types of supports, and individual units or components can be replaced or disposed of without disposing of the entire modular boat support.

Preferred embodiments of this invention are illustrated in the accompanying drawings and will be described in more detail herein below.

### SUMMARY OF THE INVENTION

The invention is an article of manufacture, comprising a modular body having a top end and a bottom end, with a bottom opening disposed at said bottom end; an interconnect assembly disposed on the top end of the modular body; and a contact extension disposed on the interconnect assembly.

The invention solves the problem of supporting a boat on dry land. The invention consists of a modular boat support with an interconnect assembly and an optional contact extension. The support can be used individually on a certain point on a boat, or multiple supports may be used by stacking them together to achieve a desired height. The advantage of the invention is the ease of storage, transport, and customization to a particular boat, as well as the aesthetics compared to current methods, and the protection to the boat hull provided by the contact extension.

Although this invention was designed primarily for use with boats, it lends itself to use with many other structures that may require support. For instance, including but not limited to, blocking a wall or other building component during construction, supporting automobiles during maintenance or manufacture, supporting ramps for boats or trucks, and supporting heavy furniture.

It is an object of the invention to support a boat on dry land.

It is an object of the invention to provide modular boat supports that can be stacked together, and can be used along the port and starboard sides and the hull of a boat in any number required to support the boat.

It is an object of the invention to provide an easily customizable method for supporting a wide range of boat types.

It is an object of the invention to provide a boat support system that is lightweight but strong.

It is an object of the invention to provide a boat support that is easy to store and transport.

It is an object of the invention to provide a boat support that is aesthetically pleasing.

It is an object of the invention to provide a boat support that is easily disposable.

It is an object of the invention to provide support for any object or structure with which it is compatible.

### BRIEF DESCRIPTION OF THE DRAWINGS

FIG. 1 is a front view of a preferred embodiment of the invention, showing a boat supported on its hull, starboard and port sides by modular boat supports of varying heights.

FIG. 2 is a side view of a preferred embodiment of the invention, showing a boat supported on the hull and port side by modular boat supports of varying heights.

FIG. 3 is an exploded perspective view of a preferred embodiment of the invention, showing a modular boat support with optional removable contact extension.

FIG. 4 is a side view of a preferred embodiment of the invention, showing a modular boat support with a contact extension in place.

FIG. 5 is a top view of a preferred embodiment of the invention, showing the modular boat support with a contact extension in place.

FIG. 6 is a bottom view of a preferred embodiment of the invention, showing that the bottom is open and specifically showing a bottom view of the reinforcement structure ribs inside of the invention.

FIG. 7 is a sectional view of a preferred embodiment of the invention, showing the inside of the modular boat support and specifically the interconnect assembly that allows modules to be stacked, and indicating the individual ribs that comprise the reinforcement structure of the invention.

FIG. 8 is side view of preferred embodiment of the invention, showing two modular boat supports stacked together.

FIG. 9 is a cut away sectional view of a preferred embodiment of the invention, showing two modular boat supports stacked together.

FIGS. 10-13 illustrate an alternate embodiment to the one described in FIGS. 1-9.

FIG. 10 is a front perspective view of the invention.

FIG. 11 is a bottom view of the invention.

FIG. 12 is a front view of the invention with the contact extension in place.

FIG. 13 is a side view of two modular boat supports stacked together.

### DESCRIPTION OF THE PREFERRED EMBODIMENTS

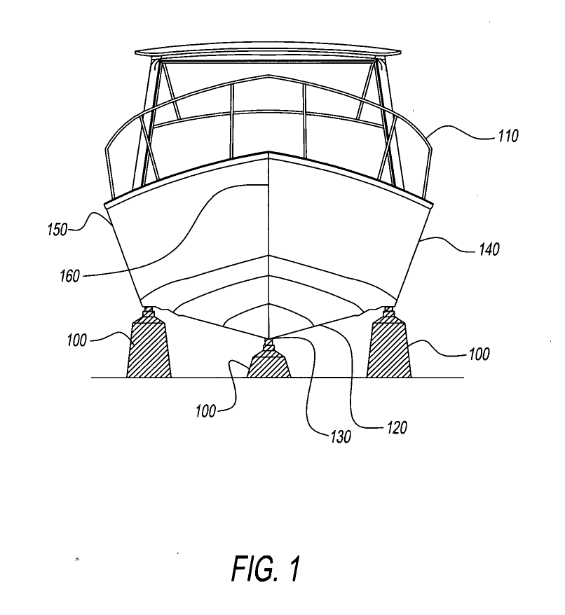

The preferred embodiments of the present invention will now be described with reference to FIG. 1-9 of the drawings. Identical elements in the various figures are identified with the same reference numerals.

The invention is a modular boat support comprised of three parts: the modular body, an interconnect assembly disposed on the top end of the modular body, and an optional contact extension disposed on the top of the interconnect assembly. Although the figures all show a cone shape for the invention, this is for illustrative purposes only and any desired shape may be used for the modular boat support.

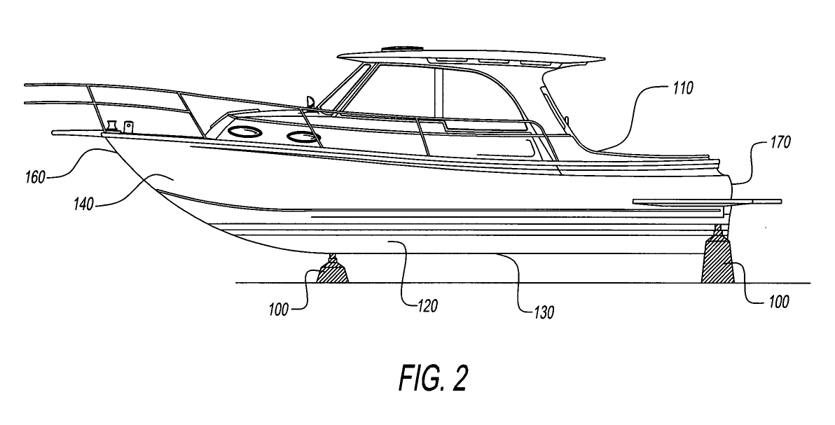

FIG. 1 and FIG. 2 show the modular boat support 100 in use. In FIG. 1, three modular boat supports 100 are shown supporting a boat 110 on the port side 140 and starboard side 150 and on the hull 120. In FIG. 2, the boat is supported on the hull 120 and port side 140 using the invention. The modular boat supports are of different heights, which is important to the customization of the support system. The walls of the modular boat support may be of thicknesses from ¼ inches to 1 inch. The modular boat supports may also be of differing widths, depending on the best fit for a certain type of boat, the widths being from 16 inches to 32 inches. The height of the modular boat support may be from 16 inches to 42 inches. The diameter or width of the contact extension may be from 3 inches to 9 inches, with a preferred diameter or width of 6 inches and a height of from 1½ inches to 6 inches. The shape of the modular boat support may be, but is not limited to, a cone, rectangle, pyramid, or tetrahedron. Also, different components of the support, such as the modular body, reinforcement structure, interconnect assembly, and contact extension may be of differing shapes and sizes.

The modular boat support body, interconnect assembly, reinforcement structure, and contact extension may be made from any material, including but not limited to: plastics and resins including but not limited to ABS, Polycarbonate, Noryl™, PVC, Polystryrene, ABS/PVC, PVC/Acrylic, Polysulfone, Acrylic, Polyethylene, Kydex™, PETG; glass, including but not limited to fiberglass, borosilicate, or quartz; wood; metals, including but not limited to iron, tin, aluminum, copper; rubbers including but not limited to natural rubber, SBR, Isoprene rubber, Butadiene rubber, and Chloroprene rubber; or any combinations or composites of these materials or other materials and new materials that may be manufactured in the future. Carbon foam, available from Touchstone Research Laboratory, Millennium Centre, Triadelphia, W. Va. 26059 is an especially preferred material. The parts to the modular boat support may be manufactured from identical or different components, and the body of the modular boat support may be manufactured using differing components in different parts.

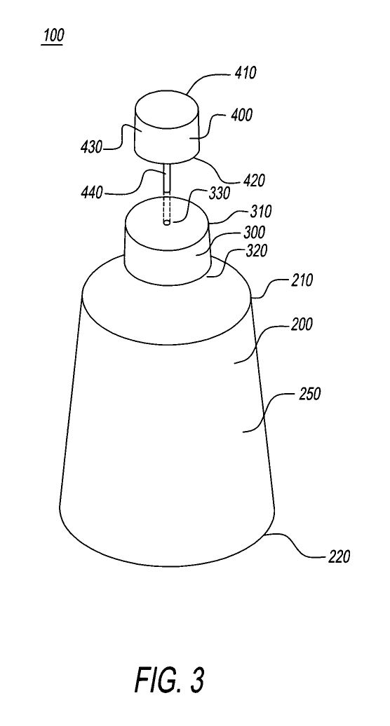

FIG. 3 illustrates the modular boat support 100, in particular the three sections of the invention and how they fit together. The modular body 200 has a top end 210, a bottom end 220 and an external wall 250. The interconnect assembly 300 has a top edge 310, a bottom edge 320, and a contact extension joiner receptacle 330 for joining it to the contact extension 400. The contact extension 400 has a top edge 410, a bottom edge 420, a side 430, and a joiner 440, for joining it to the interconnect assembly 300. Although FIG. 3 shows the modular body 200 and the interconnect assembly 300 as two separate pieces, they can either be separate or can be molded as one continuous piece.

FIG. 3 illustrates the optional nature of the contact extension 400, by showing the contact extension 400 not attached to the interconnect assembly 300. The contact extension is meant to protect the boat's hull from scratches, so although it can be manufactured from any of the materials listed with FIGS. 1 and 2, the preferred material is a malleable material that may deform and mold to the shape of the contact point with the boat. The contact extension may also be readily disposable and replaceable.

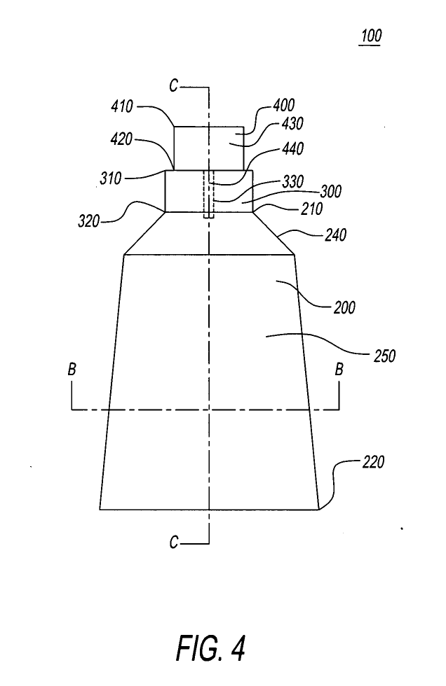

FIG. 4 shows a side view of the modular boat support 100 with the contact extension 400 attached to the interconnect assembly 300, and a shoulder 240 on the modular body 100. The modular body 200 has a top end 210, a bottom end 220 and an external wall 250. The interconnect assembly 300 has a top edge 310, a bottom edge 320, and a contact extension joiner receptacle 330 for joining it to the contact extension 400. The contact extension 400 has a top edge 410, a bottom edge 420, a side 430, and a joiner 440, for joining it to the interconnect assembly 300.

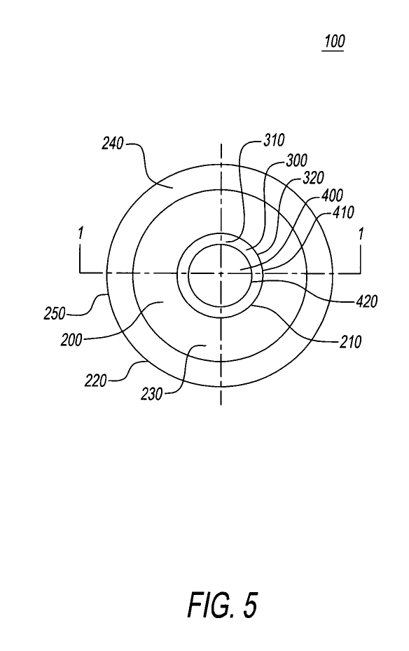

FIG. 5 is a top view of the modular boat support 100. The modular body 200 has a top end 210, a bottom end 220, a shoulder 240, and an external wall 250. The interconnect assembly 300 has a top edge 310, a bottom edge 320, and a contact extension joiner receptacle 330 for joining it to the modular boat support contact extension 400. The contact extension 400 has a top edge 410, a bottom edge 420, a side 430, and a joiner 440, for joining it to the interconnect assembly 300.

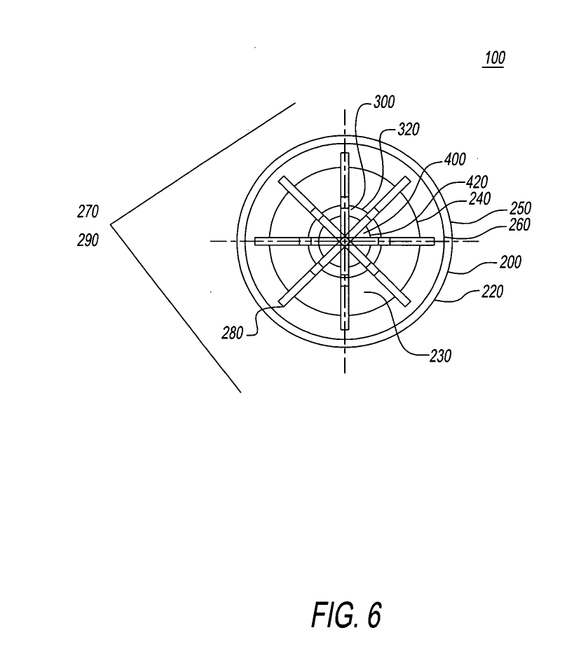

FIG. 6 is a bottom view of the invention that illustrates a preferred reinforcement structure 270 that provides strength to the modular boat support 100. FIG. 6 shows the bottom of the modular body 200, the modular body bottom end 220, the modular body opening 230, the modular body shoulder 240, the modular body external wall 250, modular body internal wall 260, modular body reinforcement structure 270, modular body reinforcing rib 280, modular body reinforcement structure bottom 290, interconnect assembly 300, interconnect assembly bottom edge 320, contact extension 400, and the contact extension bottom edge 420. The reinforcement structure 270 preferably has a series of reinforcing ribs 280, and is designed in such a way as to provide the strength needed to support a heavy load such as a boat. The preferred embodiment is shown for illustrative purposes, but this is only one potential configuration of the reinforcement structure. Any structure that allows stacking of modular boat supports may be used. A number of configurations may be used, including but not limited to, using any number of ribs, using a mesh or network of ribs, using ribs of any shape, or using a solid reinforcement structure.

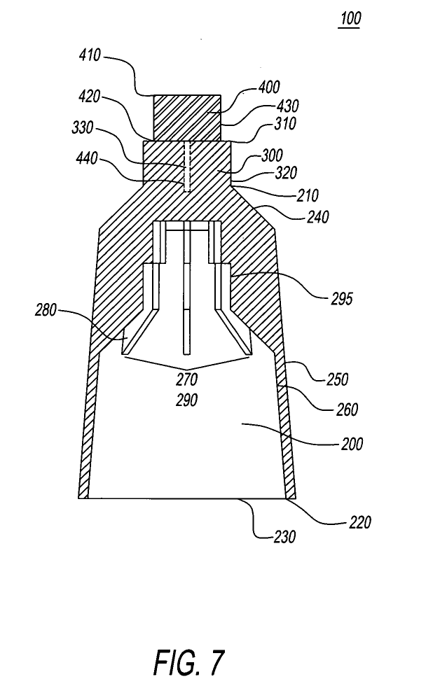

FIG. 7 is a sectional view of the modular boat support 100 with the contact extension 400 attached to the interconnect assembly 300 on the modular body 100. The modular body 200 has a top end 210, a bottom end 220, a body opening 230, a shoulder 240, an external wall 250 and an internal wall 260. Inside the modular body is the reinforcement structure 270, modular body reinforcing rib 280, the modular body reinforcement structure bottom 290, and the modular body interconnect receptacle 295. Also shown is the interconnect assembly 300. The interconnect assembly 300 has a top edge 310, a bottom edge 320, and a contact extension joiner receptacle 330 for joining it to the contact extension 400. The contact extension 400 has a top edge 410, a bottom edge 420, a side 430, and a joiner 440, for joining it to the interconnect assembly 300.

The reinforcement structure 270 may be molded as one piece or separate pieces, may be molded integrally with the support modular body 200 or molded as a piece or pieces separate from the body, and if a separate piece or pieces, it may be custom fitted to a modular body 200 or may be interchangeable between different sizes or shapes of modular bodies 200, to allow for maximum flexibility in its storage, transport, and use.

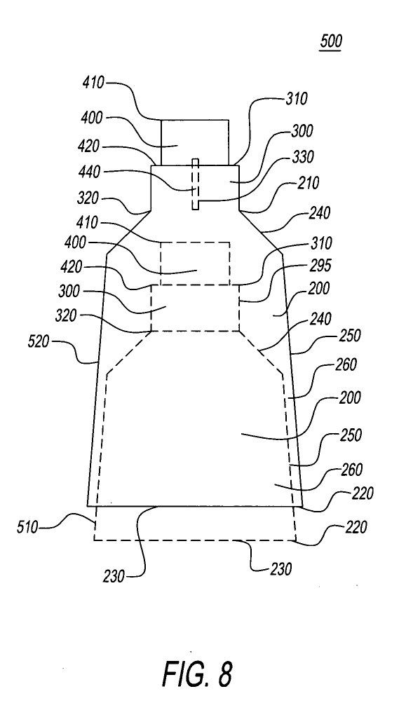

FIG. 8 is a side view of two modular boat supports 100 stacked together 500. The bottom modular boat support 510 and the top modular boat support 520 are identical, except that the top modular boat support shows contact extension joiner receptacle 330 and contact extension joiner 440. Both modular boat supports 510 and 520 show a side view of the modular boat support 100 with the contact extension 400 attached to the interconnect assembly 300. The modular body 200 has a top end 210, a bottom end 220, a body opening 230, a shoulder 240, an external wall 250, and an internal wall 260. The interconnect assembly 300 has a top edge 310 and a bottom edge 320. The contact extension 400 has a top edge 410, a bottom edge 420, and a side 430.

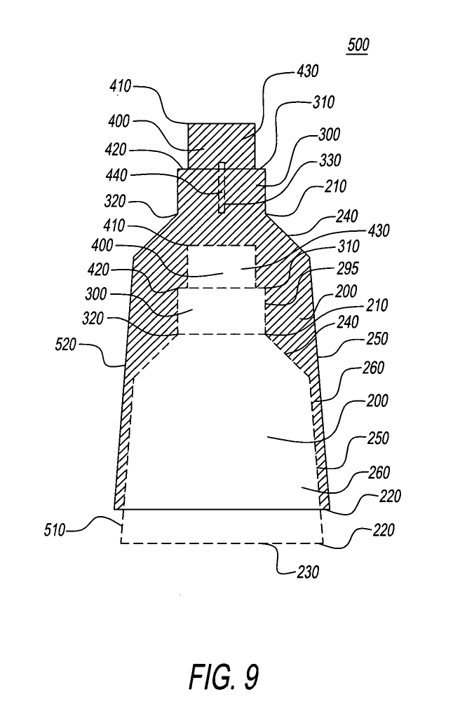

FIG. 9 shows a cut away sectional view of two modular boat supports 100 stacked together 500. The bottom modular boat support 510 and the top modular boat support 520 are identical, except that the top modular boat support shows contact extension joiner receptacle 330, contact extension joiner 440, and modular body interconnect assembly receptacle 295. The modular body interconnect assembly may be any shape which fits the corresponding male part, which may be any shape as stated earlier. “Fit” may be defined as the female part resting lightly or flush on the male part, with a range of contact from minimal to full contact. Both modular boat supports 510 and 520 show a side view of the modular boat support 100 with the contact extension 400 attached to the interconnect assembly 300. The modular body 200 has a top end 210, a bottom end 220, a body opening 230, a shoulder 240, an external wall 250, and an internal wall 260. The interconnect assembly 300 has a top edge 310 and a bottom edge 320. The modular contact extension 400 has a top edge 410, a bottom edge 420, and a side 430.

When two modular boat supports are stacked together, the bottom boat support 510 serves as the male and fits flush inside the top boat support 520 by contacting the reinforcement structure 270, which is designed to complement the male part of the invention so that a good fit is achieved and stability is maximized. The female component of the modular boat support 100 also gives strength to the entire structure so that it can support a heavy weight.

While FIGS. 8 and 9 show that the bottom boat support 510 is flush inside the top boat support 520, this is a preferred embodiment. Other configurations may include the modular boat supports resting together with minimal contact or contact at various points. Although FIGS. 8 and 9 show two modular boat supports stacked together, any number of supports may be stacked to yield a desired height. The modular boat supports that are stacked together may also be of different shapes or of different sizes, in either height or length, and they may be stacked in any order.

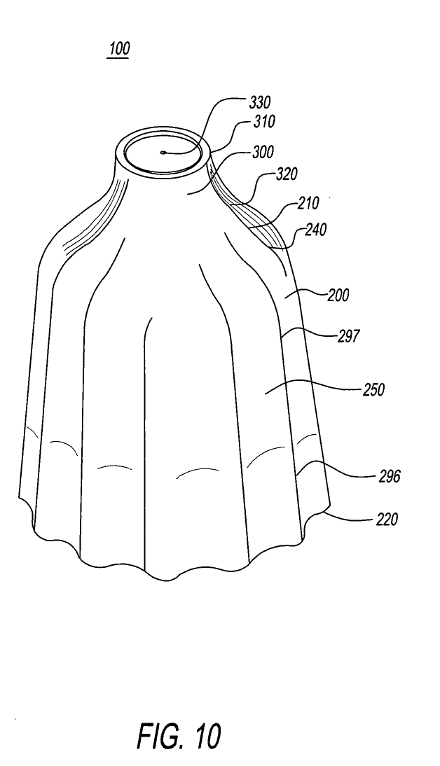

FIGS. 10-13 illustrate an alternate embodiment to the one described above.

FIG. 10 is a front perspective view of a boat support in this alternate embodiment. This embodiment illustrates a boat support 100 using external wall ribs 297 as the support structure. In this embodiment, the inner reinforcement structure described in detail in FIG. 6 is no longer present. This embodiment allows manufacture of a boat support at a lower price than that of the first embodiment, although both embodiments or a combination of the two embodiments may be used.

This embodiment also demonstrates the modular boat support handles/tethering connectors 296. These handles serve multiple purposes. For instance, one purpose includes but is not limited to carrying handles which serve for easy transportability and moveability of the boat support, even when loaded. Further, these handles serve as tethering devices, which may, for instance, hold the boat supports in place while in use or in storage. The handles may be constructed of any of the materials described herein, and may be rigid or flexible in nature. Non-limiting examples of substances from which to manufacture the handles/tethering devices include plastics, rubbers, nylons, metals, wood, and rope.

Further, the handles may be located anywhere on the boat support. Non-limiting examples include attachment on or to the modular body external wall 250 or the modular boat support external wall rib 297. Attachment may be externally or may be achieved via any means, including perforating the modular body external wall or other attachment site on the boat support 100. Other means of attachment include but are not limited to adherence via heat fusing, gluing, chemical adherence, welded, screws, fastened with clips or wires, and riveted. In addition, the attachment of the handles/tethering devices may be permanent or removable. The handles may be flush or retractable. They may also be integral with the boat support. The external body wall may be fitted with one or more attachments anywhere on the body wall for placement of one or more handles or tethering connectors.

Modular boat support external wall ribs 297 is a non-limiting example one of the numerous shapes which the modular boat support 100 may take. This embodiment has ribs provides unique support and weight distribution for the boat or heavy object being supported, and aids in the stackability of that modular boat support 100.

Although not illustrated in the drawings, the modular boat supports could be fastened together using a wide variety of means, including but not limited to wiring, hooking, welding, gluing, tying, screwing or otherwise fastening them together. The modular boat supports could be molded in such a way that they interlock, such as, but not limited to, by twisting them into a locked position.

The modular boat supports could also be configured so that it could be anchored or staked to the ground, or an intermediate platform resting on the ground such as wood, plywood, concrete, etc.

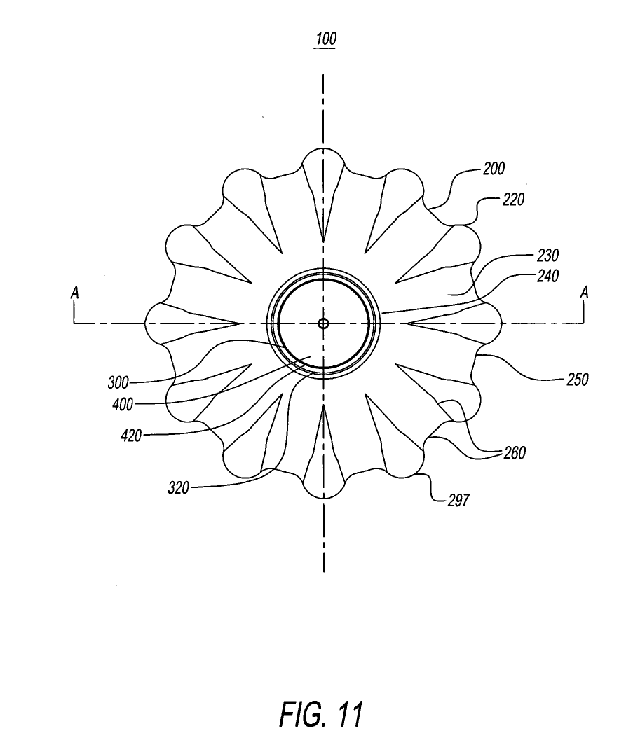

FIG. 11 is a bottom view of the alternate embodiment shown in FIG. 10 of the modular boat support 100. FIG. 11 shows the bottom of the modular body 200, the modular body bottom end 220, the modular body opening 230, the modular body shoulder 240, the modular body external wall 250, modular body internal wall 260, modular boat support external wall ribs 297, interconnect assembly 300, interconnect assembly bottom edge 320, contact extension 400, and the contact extension bottom edge 420. The preferred embodiment is shown for illustrative purposes, but this is only one potential configuration of the reinforcement structure. Any structure that allows stacking of modular boat supports may be used. A number of configurations may be used, including but not limited to, using any number of ribs, using any rib shape or length in relation to the boat support length, and using any width of rib. Ribs internal to the structure as illustrated in FIGS. 1-9.

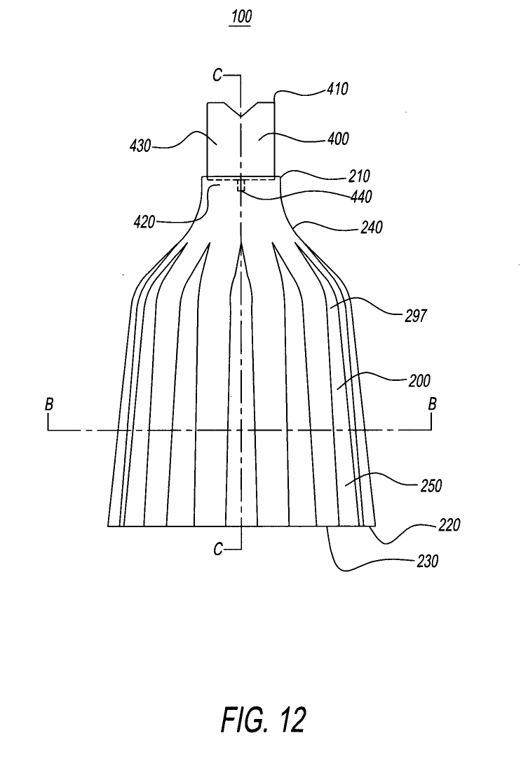

FIG. 12 is a front view of the second embodiment with the contact extension in place. FIG. 12 shows the modular boat support 100 with the contact extension 400 attached to the modular body 200. The modular body 200 has a top end 210, a bottom end 220, a body opening 230, a shoulder 240, an external wall 250, and external wall rib 297. There is a contact extension joiner receptacle 330 for joining it to the contact extension 400. The contact extension 400 has a top edge 410, a bottom edge 420, a side 430, and a joiner 440, for joining it to the modular body 200. In this embodiment, the support interconnect assembly 300 is not needed.

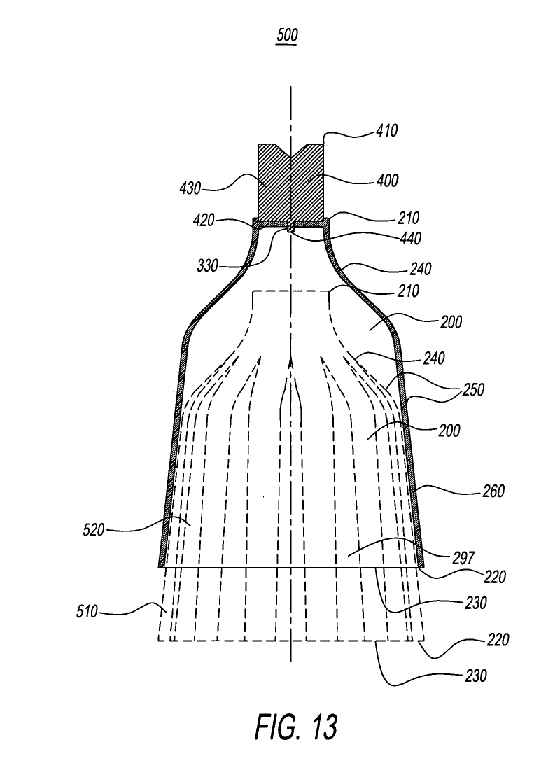

FIG. 13 is a side view of two modular boat supports 100 stacked together 500, with the contact extension 400 in place on the top modular boat support 520. The bottom modular boat support 510 and the top modular boat support 520 are otherwise identical, except that the top modular boat support shows contact extension joiner receptacle 330, contact extension top edge 410, contact extension bottom edge 420, contact extension side 430, and contact extension joiner 440. The bottom modular boat support 510 shows the external wall ribs 297 that are not shown on the top modular boat support 520.

Both modular boat supports 510 and 520 are illustrated with modular body 200 which has a top end 210, a bottom end 220, a body opening 230, a shoulder 240, and an external wall 250. The internal wall 260 can be seen in the top modular boat support 520.

When two modular boat supports are stacked together, the bottom boat support 510 serves as the male and fits flush inside the top boat support 520. The external wall ribs 297 contact and nest inside each other so that a good fit is achieved and stability is maximized.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An article of manufacture, comprising:
a modular body having a top end and a bottom end, with a bottom opening disposed at said bottom end;
an interconnect assembly disposed on the top end of the modular body; and
a contact extension disposed on the interconnect assembly.

2. The article of claim 1, wherein the modular body has a interconnect assembly receptacle.

3. The article of claim 2, wherein the modular body has a reinforcement structure.

4. The article of claim 3, wherein the reinforcement structure comprises a plurality of reinforcing ribs.

5. The article of claim 1, wherein the modular body is cone shaped.

6. The article of claim 1, wherein the modular body is rectangularly shaped.

7. The article of claim 1 wherein the modular body is tetrahedrally shaped.

8. The article of claim 1 wherein the interconnect assembly is removable.

9. The article of claim 1 wherein the modular body has a shoulder.

10. The article of claim 1 wherein the contact extension is deformable.

11. The article of claim one wherein in the modular body has a height, and the height is between 16 and 42 inches.

12. The article of claim one wherein the modular body has a maximum width and the maximum width is between 16 and 32 inches.

13. A system for supporting an object, comprising:
at least two modular supports, wherein each modular support has a modular body having a top end and a bottom end, with a bottom opening disposed at said bottom end;
an interconnect assembly disposed on the top end of the modular body; and
a contact extension disposed on the interconnect assembly.

14. The system of claim 13 wherein the modular body has an interconnect assembly receptacle, and said interconnect assembly receptacle is configured to fit another modular support.

15. The system of claim 13, wherein the system supports a boat.

16. The system of claim 15, wherein the contact extension is configured to fit under the hull edge of a boat.

17. The system of claim 13, wherein the modular supports each have different modular body heights.

18. The article of manufacture of claim 1, wherein the modular body is comprised of external wall ribs.

19. The article of manufacture of claim 1, wherein said modular support has handles/tethering connectors.
